(19) United States
(12) Patent Application Publication
(10) Pub. No.: US 2019/0385082 A1
(43) Pub. Date: Dec. 19, 2019

(54) INFORMATION PROCESSING DEVICE, INFORMATION PROCESSING METHOD, AND PROGRAM RECORDING MEDIUM

(71) Applicant: NEC Corporation, Minato-ku, Tokyo (JP)

(72) Inventor: Yoshio KAMEDA, Tokyo (JP)

(73) Assignee: NEC Corporation, Minato-ku, Tokyo (JP)

(21) Appl. No.: 16/479,248

(22) PCT Filed: Jan. 23, 2018
(86) PCT No.: PCT/JP2018/002017

§ 371 Date: Jul. 19, 2019

(30) Foreign Application Priority Data
Jan. 31, 2017 (JP) 2017-015776

(51) Int. Cl. G06N 20/00; G06F 17/50

(52) U.S. Cl. CPC G06N 20/00; G06F 17/5009

(57) ABSTRACT

An information processing device for enabling acquisition of a simulation output with high precision or in a short time, as compared with the technique disclosed in PTL 1 or 2, is provided. The information processing device includes an acquisition unit and a learning unit. The acquisition unit acquires a value of an input variable used for executing a simulation, an updated value of an internal variable updated during execution of the simulation, and a value of an output variable indicating a result of the simulation. The learning unit learns an estimation model for estimating a simulation result by using the input variable and the updated internal variable acquired by the acquisition unit as explanatory variables and the output variable acquired by the acquisition unit as an objective variable.

### TECHNICAL FIELD

The present disclosure relates to an information processing device, an information processing method, and a program recording medium.

### BACKGROUND ART

A simulation in which a physical or abstractive system is expressed by a model and an experiment using the model is conducted is executed. For example, a deformation amount when force is applied to an object (structure analysis), propagation of heat when heat is applied to a part of an object (thermal conduction analysis), motion of wind or water when wind or water hits an object (fluid analysis), and the like are simulated by a simulation device by using a mathematical model.

PTL 1 discloses a simulation method and a device thereof. In the method and device, a neural network learns a result of a simulation in which an input condition of a simulator is changed, and a simulation result with respect to a new input condition is predicted by using the neural network. Consequently, a simulation result under a new input condition is speedily acquired.

PTL 2 discloses an analysis device for analyzing a system which inputs input data including a plurality of input parameters, and outputs output data. In the device, a difference amount of output data according to a difference between input parameters of two pieces of input data is learned, based on a plurality of sets of learning data on input data and output data, and a change amount of output data is predicted according to a change amount of an input parameter. Consequently, a time and a processing amount for acquiring output data of a system are reduced.

PTL 3 discloses a moving means estimation model generation device for generating a moving means estimation model capable of estimating a moving means with high precision.

PTL 4 discloses an information processing device for specifying a condition in which a favorable result is acquired from among a plurality of scenarios in an agent-based simulation, with a smaller calculation amount.

PTL 5 discloses an information processing device for setting a parameter appropriate for pattern identification, while suppressing a processing amount and a memory capacity required for processing.

PTL 6 discloses a simulation system capable of grasping accumulation of individual pieces of constituent model result data, an overall status, and a change, and expediting company/organization diagnosis and decision making.

### CITATION LIST

### Patent Literature

[PTL 1] Japanese Patent Application Laid-Open Publication No. H3-265064

[PTL 2] Japanese Patent Application Laid-Open Publication No. 2016-006587

[PTL 3] Japanese Patent Application Laid-Open Publication No. 2016-081272

[PTL 4] Japanese Patent Application Laid-Open Publication No. 2016-071383

[PTL 5] Japanese Patent Application Laid-Open Publication No. 2015-087940

[PTL 6] Japanese Patent Application Laid-Open Publication No. 2009-295017

### SUMMARY OF INVENTION

### Technical Problem

Generally, a simulation device generates an output variable while updating an internal variable by using an input variable. However, there is a problem that it is necessary to execute a simulation for a long time in order to acquire a high-precision output variable.

In the techniques disclosed in PTLs 1 and 2 described above, although it is possible to reduce a simulation time, estimation precision on output may be lowered.

PTLs 3 to 6 fail to disclose a technique for solving the above-described problem.

In view of the above-described problem, a main object of the invention of the present application is to provide an information processing device and the like for generating an estimation model capable of acquiring a simulation output with high precision or in a short time, as compared with the technique disclosed in PTL 1 or 2.

### Solution to Problem

An information processing device according to an exemplary aspect of the present invention includes: acquisition means for acquiring a value of an input variable used for executing a simulation, an updated value of an internal variable updated during execution of the simulation, and a value of an output variable indicating a result of the simulation; and learning means for learning an estimation model for estimating a simulation result by using the input variable and the updated internal variable acquired by the acquisition means as explanatory variables and the output variable acquired by the acquisition means as an objective variable.

An information processing method according to an exemplary aspect of the present invention includes: acquiring a value of an input variable used for executing a simulation, an updated value of an internal variable updated during execution of the simulation, and a value of an output variable indicating a result of the simulation; and learning an estimation model for estimating a simulation result by using the input variable and the updated internal variable acquired by the acquisition means as explanatory variables and the output variable acquired by the acquisition means as an objective variable.

A computer readable storage medium according to an exemplary aspect of the present invention records thereon a program, causing a computer to execute processes including: acquiring a value of an input variable used for executing a simulation, an updated value of an internal variable updated during execution of the simulation, and a value of an output variable indicating a result of the simulation; and learning an estimation model for estimating a simulation result by using the input variable and the updated internal variable acquired by the acquisition means as explanatory variables and the output variable acquired by the acquisition means as an objective variable.

### Advantageous Effects of Invention

According to the invention of the present application, an advantageous effect of enabling acquisition of a simulation output with high precision or in a short time, as compared with the technique disclosed in PTL 1 or 2, is acquired.

### BRIEF DESCRIPTION OF DRAWINGS

FIG. 1 is a block diagram illustrating a configuration of an information processing device according to a first example embodiment of the present invention.

FIG. 2 is a block diagram illustrating a configuration of an information processing device according to a second example embodiment of the present invention.

FIG. 3 is a diagram illustrating one example of input variables stored in advance in a first input variable storage unit of the information processing device according to the second example embodiment of the present invention.

FIG. 4 is a flowchart illustrating processing of an output estimation model generation phase in the information processing device according to the second example embodiment of the present invention.

FIG. 5 is a diagram describing one example of an interim progress of executing a simulation by a simulation unit of the information processing device according to the second example embodiment of the present invention.

FIG. 6 is a diagram illustrating one example of input variables, updated values of internal variables, and simulation results stored in a simulation result storage unit of the information processing device according to the second example embodiment of the present invention.

FIG. 7 is a flowchart illustrating output estimation model generation processing by an output estimation model generation unit of the information processing device according to the second example embodiment of the present invention.

FIG. 8 is a diagram illustrating one example of an output estimation model generated by the output estimation model generation unit of the information processing device according to the second example embodiment of the present invention.

FIG. 9 is a flowchart illustrating processing of an output variable estimation phase by the information processing device according to the second example embodiment of the present invention.

FIG. 10A is a diagram illustrating one example of data stored in the simulation result storage unit of the information processing device according to the second example embodiment of the present invention.

FIG. 10B is a diagram illustrating one example of an estimation result stored in an estimation result storage unit by an estimation unit of the information processing device according to the second example embodiment of the present invention.

FIG. 11 is a block diagram illustrating a configuration of an information processing device according to a third example embodiment of the present invention.

FIG. 12 is a diagram illustrating one example of a relationship between a simulation result by the information processing device according to the third example embodiment of the present invention, and an estimated value of an output variable by an output estimation model.

FIG. 13 is a flowchart illustrating processing of generating an error estimation model by an error estimation model generation unit of the information processing device according to the third example embodiment of the present invention.

FIG. 14 is a diagram illustrating error data including an error calculated by the error estimation model generation unit of the information processing device according to the third example embodiment of the present invention.

FIG. 15 is a diagram illustrating one example of an output estimation model generated by an output estimation model generation unit, and an error estimation model generated by the error estimation model generation unit, of the information processing device according to the third example embodiment of the present invention.

FIG. 16 is a block diagram illustrating a configuration of an information processing device according to a fourth example embodiment of the present invention.

FIG. 17 is a flowchart illustrating processing of a precision determination unit of the information processing device according to the fourth example embodiment of the present invention.

FIG. 18 is a diagram illustrating one example of a relationship between a step number of an output estimation model by the information processing device according to the fourth example embodiment of the present invention, and an average value of error of an estimated value of an output variable by the model.

FIG. 19 is a block diagram illustrating a configuration of an information processing device according to a fifth example embodiment of the present invention.

FIG. 20 is a flowchart illustrating processing of a relearning determination unit of the information processing device according to the fifth example embodiment of the present invention.

FIG. 21 is a diagram illustrating one example of input variables, updated values of internal variables, and simulation results stored in an additional simulation result storage unit of the information processing device according to the fifth example embodiment of the present invention.

FIG. 22 is a diagram illustrating one example of an estimation result calculated by the relearning determination unit of the information processing device according to the fifth example embodiment of the present invention.

FIG. 23 is a flowchart describing relearning determination processing by the relearning determination unit of the information processing device according to the fifth example embodiment of the present invention.

FIG. 24 is a diagram illustrating one example of a hardware configuration for implementing a device illustrated in each of the example embodiments.

### EXAMPLE EMBODIMENT

In the following, example embodiments of the present invention are described in detail with reference to the drawings.

### First Example Embodiment

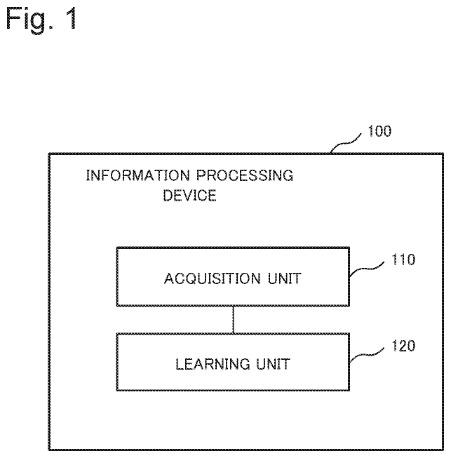

FIG. 1 is a block diagram illustrating a configuration of an information processing device 100 according to a first example embodiment of the present invention. As illustrated in FIG. 1, the information processing device 100 includes an acquisition unit 110 and a learning unit 120.

The acquisition unit 110 acquires a value of an input variable used for executing a simulation, an updated value of an internal variable updated during the execution of the simulation, and a value of an output variable indicating a result of the simulation. The learning unit 120 learns an estimation model for estimating a simulation result using the input variable and the updated internal variable acquired by the acquisition unit 110 as explanatory variables, and the output variable acquired by acquisition means as an objective variable. Note that, as one example, the learning unit 120 is implemented by an output estimation model generation unit 241 described in the following example embodiments.

By employing the above-described configuration, according to the first example embodiment, an estimation model using not only an input variable but also an internal variable as explanatory variables is generated, and a simulation result is estimated using the estimation model. Therefore, an advantageous effect of enabling acquisition of a simulation output with high precision or in a short time, as compared with a technique disclosed in PTL1 or 2, is acquired.

### Second Example Embodiment

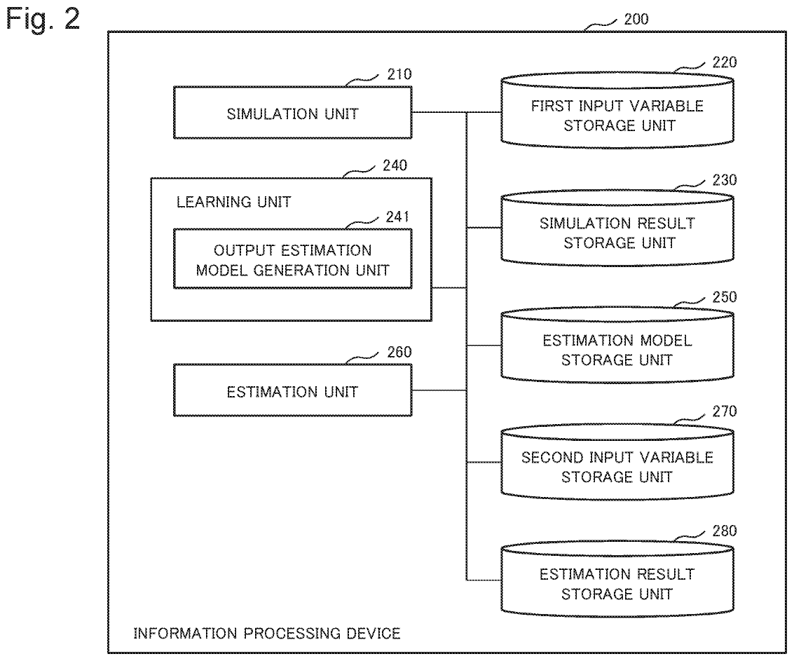

FIG. 2 is a block diagram illustrating a configuration of an information processing device 200 according to a second example embodiment of the present invention. As illustrated in FIG. 2, the information processing device 200 includes a simulation unit 210, a first input variable storage unit 220, a simulation result storage unit 230, a learning unit 240, an estimation model storage unit 250, an estimation unit 260, a second input variable storage unit 270, and an estimation result storage unit 280. The information processing device 200 is a device for executing a simulation, and generating an output estimation model for estimating a simulation result, based on a result of the simulation.

The simulation unit 210 has a function of executing a simulation. Specifically, the simulation unit 210 includes a predetermined simulation execution model, executes a simulation, while updating a value of an internal variable using the model, and a value of an input variable stored in the first input variable storage unit 220 for executing the simulation, and outputs a value of an output variable.

The first input variable storage unit 220 stores, in advance of execution of a simulation, a value of an input variable to be input to a simulation execution model.

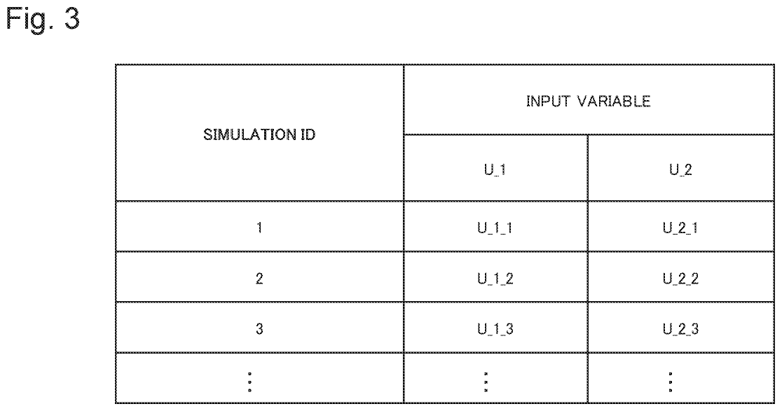

FIG. 3 is a diagram illustrating one example of values of input variables stored in advance in the first input variable storage unit 220. The first input variable storage unit 220 stores a value of an input variable for each simulation identification (ID). The simulation ID is an identifier appended to each execution of a simulation. Herein, for example, two input variables U_1 and U_2 are stored for each simulation ID.

Note that the simulation unit 210 and the first input variable storage unit 220 may not be included in the information processing device 200. In this case, the information processing device 200 may include an acquisition means for acquiring a value of an input variable of a simulation executed using the value of the input variable for executing the simulation, and an updated value of an internal variable during execution of the simulation. Further, a simulation by the simulation unit 210 in the following description may be executed on the outside, and the information processing device 200 may acquire a result of the simulation.

The simulation result storage unit 230 stores values of input variables input to the simulation unit 210 for executing a simulation, updated values of internal variables generated by executing the simulation, and simulation results (values of output variables). The input variables for executing the simulation, the updated values of internal variables, and the simulation results are used as learning data for generating an output estimation model described later.

The learning unit 240 includes an output estimation model generation unit 241. The output estimation model generation unit 241 also serves as an acquisition unit (not illustrated) for acquiring learning data stored in the simulation result storage unit 230. The output estimation model generation unit 241 generates an output estimation model for estimating a value of an output variable after a simulation converges (hereinafter, also referred to as a “convergence value”) by learning the acquired learning data. The estimation model storage unit 250 stores the output estimation model generated by the output estimation model generation unit 241.

The simulation unit 210 holds in advance a simulation execution model such as a mathematical model, which expresses a physical or abstractive system. The simulation execution model, in execution of a simulation, repeatedly executes a step (processing) until a value of an output variable is determined to be converged, while updating an internal variable using an input value of an input variable. Note that, the information processing device 200 may acquire the value of the input variable used for executing the simulation as described above, and the updated value of the internal variable during execution of the simulation.

The estimation unit 260 estimates a value of an output variable after convergence of a simulation by using an output estimation model stored in the estimation model storage unit 250, and a new value of an input variable stored in the second input variable storage unit 270.

The second input variable storage unit 270 stores a new value of an input variable for executing a simulation (hereinafter, also referred to as an “input variable for estimation”). The estimation unit 260 estimates a value of an output variable after convergence of the simulation using the value of the input variable for estimation and an output estimation model. Note that, the input variable for estimation is not limited to be stored in the second input variable storage unit 270, but may be given from the outside.

The estimation result storage unit 280 stores a value of an output variable after convergence of a simulation, which is estimated using an output estimation model by the estimation unit 260. The value of the output variable after convergence of the simulation, which is estimated using the output estimation model, is also referred to as an “estimated value”.

The information processing device 200 executes an output estimation model generation phase, in which the above-described learning data is learned and an output estimation model for estimating a value of an output variable after convergence of a simulation is generated, and an estimation phase, in which a convergence value of the output variable is estimated using the generated output estimation model and an input variable for estimation. The output estimation model generation phase is mainly executed by the simulation unit 210 and the learning unit 240, and the estimation phase is mainly executed by the estimation unit 260.

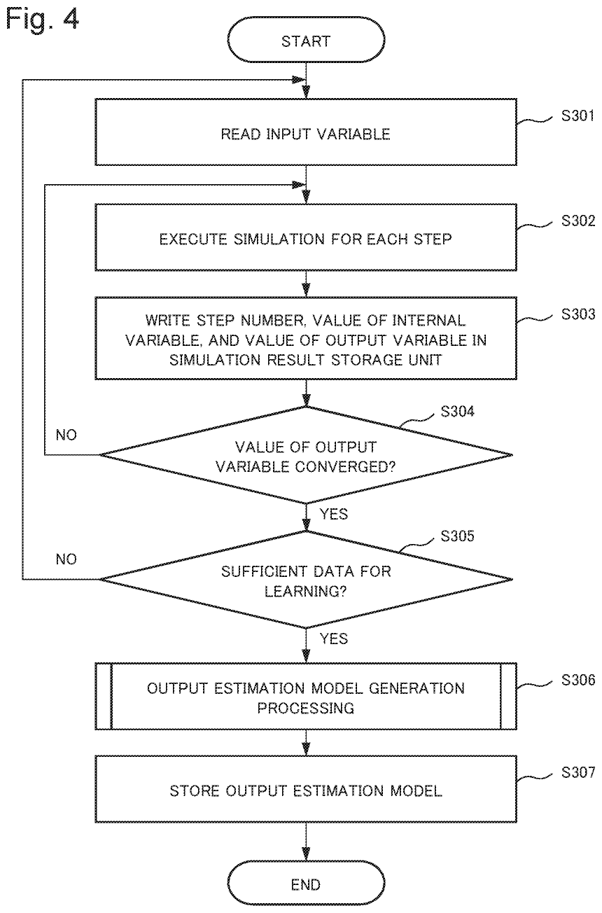

FIG. 4 is a flowchart illustrating processing of the output estimation model generation phase in the information processing device 200. Processing of the output estimation model generation phase by the information processing device 200 is described with reference to FIG. 4.

The simulation unit 210 reads a value of an input variable from the first input variable storage unit 220 (S301).

The simulation unit 210 repeatedly executes a step in which a value of an internal variable is updated and a value of an output variable is generated using the read value of the input variable and a simulation execution model (S302).

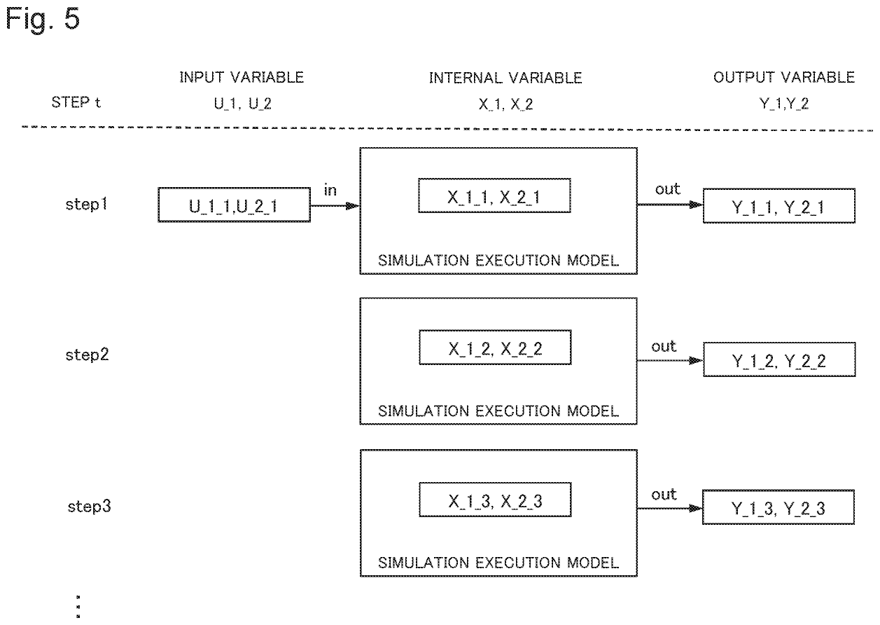

FIG. 5 is a diagram describing one example of an interim progress of executing a simulation by the simulation unit 210. In FIG. 5, the simulation unit 210 inputs, in Step 1, input variables U_1 and U_2 (values are U_1_1 and U_2_1) to a simulation execution model. The simulation unit 210 executes the simulation execution model using internal variables X_1 and X_2 (values are X_1_1 and X_2_1), and outputs output variables Y_1 and Y_2 (values are Y_1_1 and Y_2_1).

As a result of Step 1, the values of the internal variables are updated. Subsequently, in Step 2, the simulation unit 210 executes the simulation execution model using the updated values X_1_2 and X_2_2 of the internal variables in Step 1. Further, the simulation unit 210 outputs the values Y_1_2 and Y_2_2 of the output variables. Hereinafter, similarly, the simulation unit 210 outputs values of the output variables, while updating values of the internal variables. The simulation unit 210 repeatedly executes the step until values of the output variables converge.

The simulation unit 210 writes, in the simulation result storage unit 230, a step number, an updated value of the internal variable, and a value of the output variable, for each step of the simulation execution model (S303). Note that, a value of the input variable may be written in the simulation result storage unit 230, when being input to the simulation execution model, for example.

As a result of repeating the above-described step, it is assumed that the simulation unit 210 determines that a value of the output variable has converged (Yes in S304). Note that, the simulation unit 210 may hold in advance a step number by which a value of the output variable is conceived to converge, as a predetermined step number, and repeat the step by the step number.

Subsequently, the simulation unit 210 determines whether or not data sufficient for learning are acquired. An amount of data sufficient for learning may be determined in advance.

When it is determined that data sufficient for learning are not acquired, the simulation unit 210 returns the processing to S301. The simulation unit 210 reads, from the first input variable storage unit 220, a value of the input variable associated with the next simulation ID. Further, the simulation unit 210 performs the processing S302 and S303 until the output variable converges using the read value of the input variable. The simulation unit 210 repeats the processing S301 to S304 until data sufficient for learning are acquired.

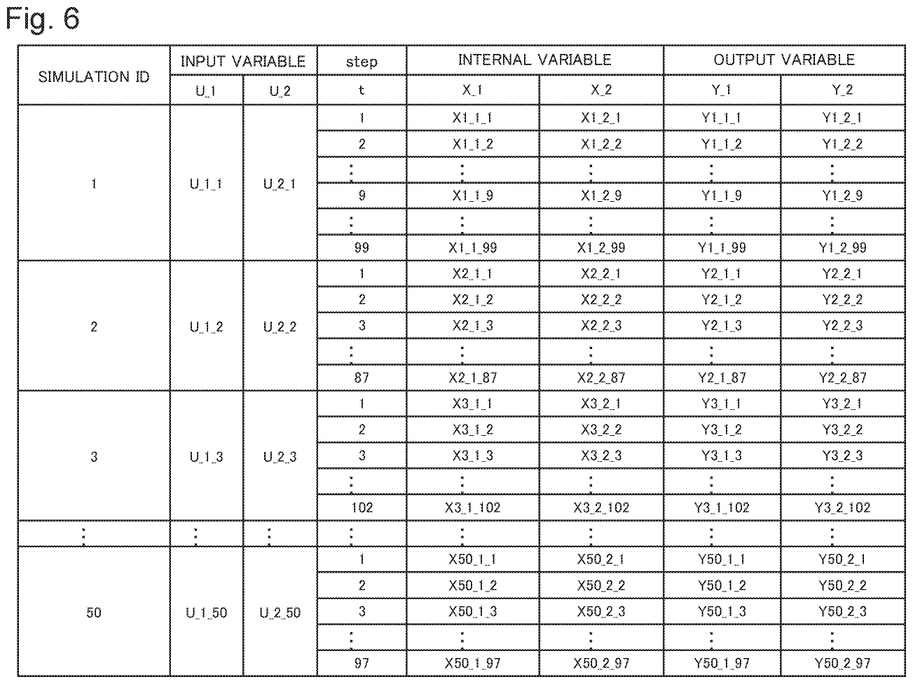

FIG. 6 is a diagram illustrating one example of values of input variables, updated values of internal variables, and simulation results written in the simulation result storage unit 230, as a result of executing the simulation. FIG. 6 illustrates that the simulation is executed fifty times as indicated by the simulation IDs 1 to 50, and a step is repeatedly executed until output variables converge in each simulation. For example, convergence values of the output variables of the simulation indicated by the simulation ID=1 are Y1_1_1_99 and Y1_2_99, and convergence values of the output variables of the simulation indicated by the simulation ID=2 are Y2_1_87 and Y2_2_87.

As illustrated in FIG. 6, updated values of internal variables and values of output variables for each step are generated for each simulation ID. FIG. 6 illustrates that values of two input variables U_1 and U_2 are input, and values of two internal variables X_1 and X_2 and values of two output variables Y_1 and Y_2 are generated for each step.

It is assumed that the simulation unit 210 determines that data sufficient for learning are acquired (Yes in S305). Subsequently, the simulation unit 210 instructs the learning unit 240 to execute output estimation model generation processing.

The learning unit 240 executes the output estimation model generation processing in the output estimation model generation unit 241 in response to the instruction (S306). Specifically, the output estimation model generation unit 241 generates an output estimation model by learning a value of the input variable, an updated value of the internal variable, and the simulation result stored in the simulation result storage unit 230.

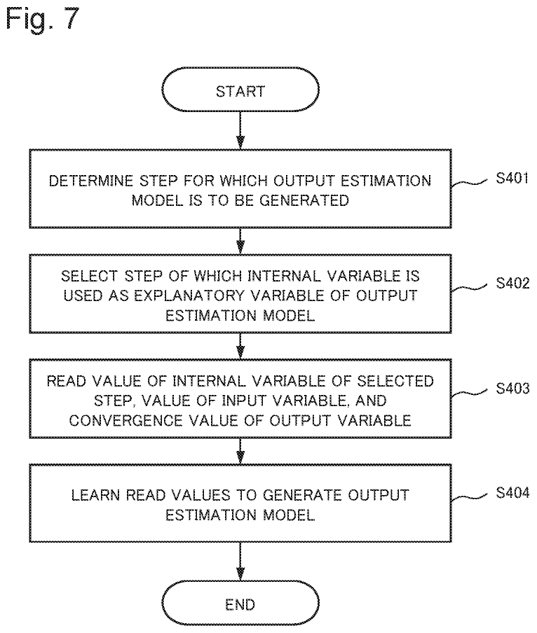

FIG. 7 is a flowchart illustrating the output estimation model generation processing by the output estimation model generation unit 241. The output estimation model generation processing by the output estimation model generation unit 241 is described with reference to FIG. 7.

First, the output estimation model generation unit 241 determines a step t (t indicates a step number) for which the output estimation model is to be generated (S401). Herein, an “output estimation model for a step t” is a model to be learned by using, as explanatory variables, an updated value of an internal variable in any one or more steps, which is acquired when a step is repeatedly executed until the step t using a certain input variable, and a value of the certain input variable in estimation processing using the output estimation model. The estimation processing will be described later. For example, an output estimation model for a step t=“10” is a model to be learned by using, as explanatory variables, an updated value of an internal variable in any one or more steps, which is acquired when the simulation unit 210 repeatedly executes a step until the step t=“10”, and a value of an input variable in estimation processing.

Herein, it is preferable to use a less step number t for which an output estimation model is generated. Specifically, it is preferable to generate an output estimation model for a step t=“30”, as compared with an output estimation model for a step t=“50”.

This is because, in estimation processing of a convergence value of an output variable by the estimation unit 260, it is necessary to execute a simulation by the simulation unit 210 until a step for which an output estimation model is generated (details will be described later). Therefore, it is preferable to generate an output estimation model for a small step number in order to execute the estimation processing in a shorter time. Note that the output estimation model generation unit 241 may hold in advance a step number for an output estimation model.

It is assumed that the output estimation model generation unit 241 determines a step t=“10” for which an output estimation model is to be generated, for example.

Next, the output estimation model generation unit 241 selects a step number of which a value of an internal variable is to be used as an explanatory variable of an output estimation model in output estimation model generation (S402). Herein, a step number smaller than the step number determined in S401 is selected.

The output estimation model generation unit 241 may select the step number as described in the following, for example. Specifically, the output estimation model generation unit 241 may use, as an explanatory variable of an output estimation model for the step t=“10”, a value of an internal variable of a step t=“9” in each simulation. Alternatively, the output estimation model generation unit 241 may use, as explanatory variables, values of the internal variable of steps t=“1” to “9” in each simulation. Further alternatively, the output estimation model generation unit 241 may use, as explanatory variables, values of the internal variable of steps t=“1”, “3”, “5”, “7”, and “9” in each simulation. As an explanatory variable, an updated value of an internal variable in at least one step may be used. Alternatively, updated values of the internal variable in two or more steps may be used.

Further, the output estimation model generation unit 241 may have a feature selection function, and may use a value of an internal variable of a step selected by the function as an explanatory variable. In the feature selection function, a value of an input variable and updated values of internal variables (X_1(t=1), X_1(t=2), . . . , and X_1(t=N), and X_2(t=1), X_2(t=2), . . . , and X_2(t=N)) in respective steps are input as candidates for explanatory variables. Herein, N indicates a step number when a simulation is determined to have converged, and X_1(t=1) indicates a value of an internal variable X_1 in a step t=“1”, respectively.

The feature selection function selects, as an explanatory variable, a preferable variable from among input candidates. In this case, for example, when there are variables having strong correlation among a plurality of variables, the output estimation model generation unit 241 may exclude some of the plurality of variables. Further, the output estimation model generation unit 241 may select, as an explanatory variable, an updated value of an internal variable in a small step number prior to an updated value of the internal variable in a large step number. A reason for this is that an “advantageous effect of enabling acquisition of a simulation output in a short time”, which will be described later, becomes more conspicuous by not using an updated value of the internal variable in a large step number as an explanatory variable. Such a feature selection function is implemented by any method. For example, as a criterion for evaluating goodness of an explanatory variable, a term indicating penalty with respect to a magnitude of a step number may be included, in addition to a term indicating an amount of correlation with an objective variable, or lowness of redundancy with another variable. The output estimation model generation unit 241 may receive, from an operator, an explicit instruction as to which variable is used as an explanatory variable.

Subsequently, the output estimation model generation unit 241 reads, from the simulation result storage unit 230, a value of an internal variable of a step number selected in S402, a value of an input variable associated with each internal variable, and a convergence value of an output variable of the simulation executed using the value of the input variable, respectively (S403).

In the example illustrated in FIG. 6, when an internal variable of a step t=“9” in each simulation is selected in S402, for example, first, the output estimation model generation unit 241 reads values U_1_1 and U_2_1 of input variables, values X1_1_9 and X1_2_9 of internal variables, and convergence values Y1_1_99 and Y1_2_99 of output variables relating to the simulation ID=“1”. Subsequently, the output estimation model generation unit 241 reads values U_1_2 and U_2_2 of the input variables, values X2_1_9 and X2_2_9 of the internal variables, and convergence values Y2_1_87 and Y2_2_87 of the output variables, relating to the simulation ID=“2”. Subsequently, the output estimation model generation unit 241 reads values U_1_3 and U_2_3 of the input variables, values X3_1_9 and X3_2_9 of the internal variables, and convergence values Y3_1_102 and Y3_2_102 of the output variables, relating to the simulation ID=“3”. The output estimation model generation unit 241 reads values relating to the simulation ID=“4” and thereafter, similarly.

The output estimation model generation unit 241 learns the read value of the input variable, the read updated value of the internal variable, and the read convergence value of the output variable to generate an output estimation model (S404). The output estimation model generation unit 241 learns using the input variable and the updated internal variable as explanatory variables, and the output variable as an objective variable. In the learning, a well-known regression analysis method such as a linear regression analysis may be employed, or any other analysis method may be employed. The output estimation model generation unit 241 completes the output estimation model generation processing illustrated in FIG. 7 according to the above-described procedure.

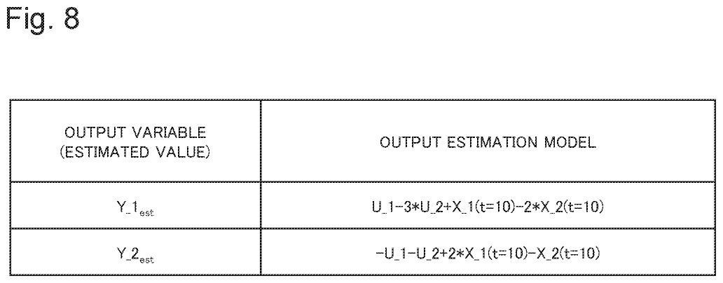

FIG. 8 is a diagram illustrating one example of an output estimation model generated by the output estimation model generation unit 241. With the output estimation model, an estimated value of a convergence value of the output variable of the simulation (hereinafter, also referred to as an “estimated value of the output variable” or an “estimated value”) is acquired. The example of FIG. 8 illustrates an output estimation model for the step t=“10”.

Specifically, the example of FIG. 8 illustrates that equations (2) and (3) are generated, as an output estimation model for acquiring estimated values Y_1ₑₛₜ and Y_2ₑₛₜ of output variables.

Estimated value Y_1ₑₛₜ=U_1−3*U_2+X_1(t=10)−2*X_2(t=10) Equation (2)

Estimated value Y_2ₑₛₜ=−U_1−U2+2*X_1(t=10)−X_2(t=10) Equation (3)

The output estimation model generation unit 241 generates the output estimation model according to the above-described procedure, and stores the generated output estimation model in the estimation model storage unit 250 (S307 in FIG. 4).

Subsequently, an estimation phase of estimating a convergence value using an output estimation model generated as described above is described. Note that the estimation phase may not necessarily be executed at a same timing as the above-described output estimation model generation phase. Specifically, the estimation phase may be executed at any timing after an output estimation model is generated. A value of an input variable for estimation may be stored in the second input variable storage unit 270 at a timing when the estimation phase is executed.

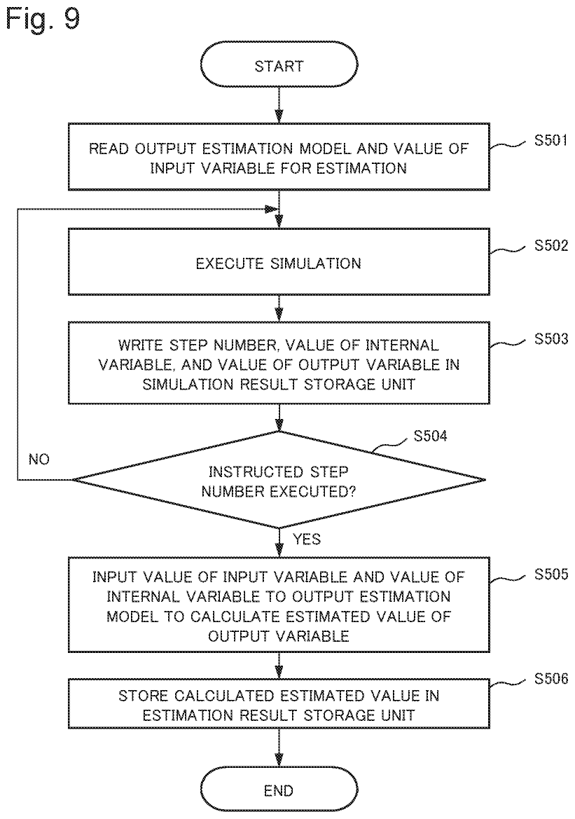

FIG. 9 is a flowchart illustrating processing of the output variable estimation phase by the information processing device 200. Processing of the estimation phase by the information processing device 200 is described with reference to FIG. 9. Herein, it is assumed that the estimation model storage unit 250 stores an output estimation model for the step t=“10” generated by the output estimation model generation unit 241, and the second input variable storage unit 270 stores a value of an input variable for estimation.

The estimation unit 260 reads an output estimation model stored in the estimation model storage unit 250, and values U_1_est and U_2_est of an input variable U_1 stored in the second input variable storage unit 270 for estimation (S501).

The estimation unit 260 instructs the simulation unit 210 to execute a simulation using the read input variable for estimation. Herein, the estimation unit 260 instructs a step number to be executed to the simulation unit 210. Herein, since an output estimation model for the step t=“10” is used, the estimation unit 260 instructs the step t=“10”.

The simulation unit 210 executes a simulation using the received values U_1_est and U_2_est of the input variable for estimation, and a simulation execution model (S502). The simulation unit 210 writes, in the simulation result storage unit 230, a step number, an updated value of an internal variable, and a value of an output variable, for each step of the simulation execution model (S503). Note that, the value of the input variable for estimation may be written in the simulation result storage unit 230, when the value is input to the simulation execution model, for example.

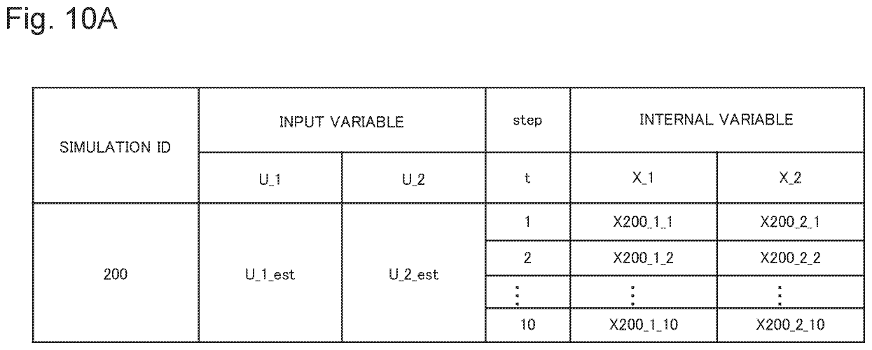

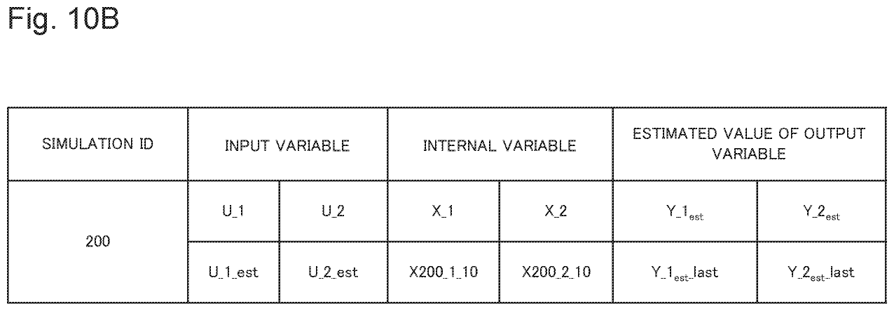

FIG. 10A is a diagram illustrating one example of input variables, a step number, and updated values of internal variables written in the simulation result storage unit 230 for a simulation having the simulation ID=“200”. As illustrated in FIG. 10A, herein, it is illustrated that a step is repeatedly executed until the step t=“10”.

When the step is executed by the instructed step number (Yes in S504), the simulation unit 210 notifies the estimation unit 260 of the execution. When receiving the notification, the estimation unit 260 estimates a convergence value of the output variable by inputting, to the output estimation model, the values U_1_est and U_2_est of the input variables stored in the simulation result storage unit 230, and values X200_1_10 and X200_2_10 of the internal variables of the instructed step t (herein, the step t=“10”) (S505).

The estimation unit 260 stores the estimated estimation result in the estimation result storage unit 280 (S506).

FIG. 10B is a diagram illustrating one example of an estimation result stored in the estimation result storage unit 280 by the estimation unit 260. FIG. 10B illustrates values of the input variables, values of internal variables, and estimated values of output variables calculated by using an output estimation model. The example illustrated in FIG. 10B indicates values U_1_est and U_2_est of the input variables, values X200_1_10 and X200_2_10 of the internal variables, and estimated values Y_1ₑₛₜ last and Y_2ₑₛₜ last of the output variables calculated by using the output estimation model.

The estimation unit 260 may display, on a display device, the estimated values of the output variables calculated as illustrated in FIG. 10B.

The estimation unit 260 performs estimation of convergence values of the output variable by the output estimation model according to the above-described procedure.

As described above, according to the second example embodiment, in the information processing device 200, the output estimation model generation unit 241 of the learning unit 240 learns a value of an input variable input to the simulation unit 210, an updated value of an internal variable acquired by executing a simulation, and a simulation result; and generates an output estimation model. The estimation unit 260 estimates a convergence value of an output variable of the simulation using the output estimation model.

By employing this configuration, in the second example embodiment, an advantageous effect of enabling acquisition of a simulation output in a short time is acquired, since a simulation result is estimated using the output estimation model without executing the simulation until the simulation result converges.

Further, an advantageous effect of enabling acquisition of the simulation output with high precision, as compared with a technique disclosed in PTL 1 or 2, is acquired, since an output estimation model using not only an input variable but also an internal variable as explanatory variables is generated, and estimation is performed by using the output estimation model.

### Third Example Embodiment

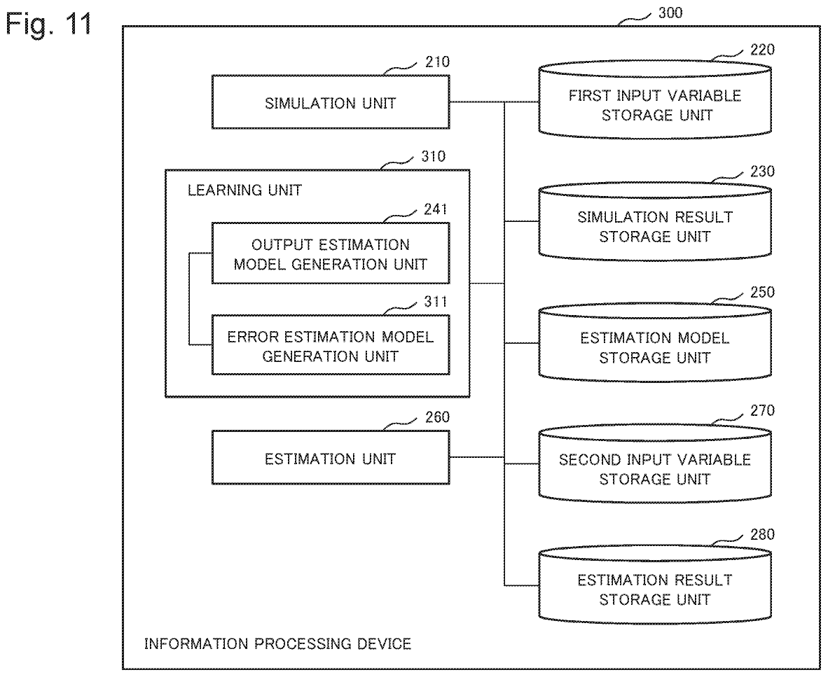

FIG. 11 is a block diagram illustrating a configuration of an information processing device 300 according to a third example embodiment of the present invention. As illustrated in FIG. 11, the information processing device 300 according to the third example embodiment includes a learning unit 310, in place of the learning unit 240 of the information processing device 200 described in the second example embodiment. Since other elements are similar to the elements described in the second example embodiment, description thereof is omitted.

The learning unit 310 includes an error estimation model generation unit 311, in addition to the output estimation model generation unit 241 described in the second example embodiment.

The error estimation model generation unit 311 generates a model for estimating an error of an estimated value of an output variable calculated using an output estimation model. A model for estimating the error of the estimated value calculated using the output estimation model is referred to as an “error estimation model”. In the present example embodiment, generating an error estimation model, based on an output estimation model for the step t=“10”, is described.

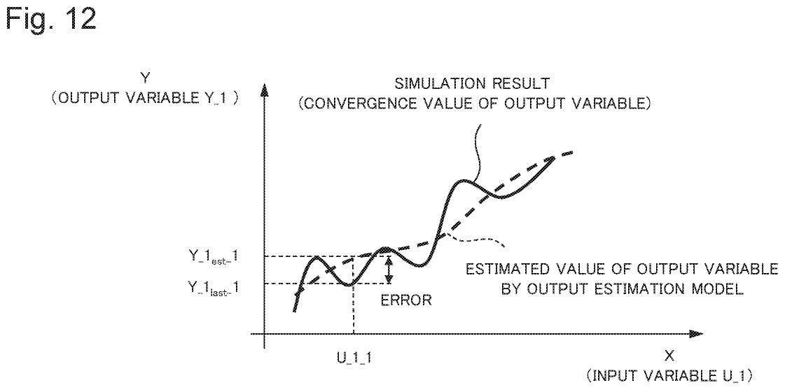

FIG. 12 is a diagram illustrating one example schematically describing a relationship between a simulation result (convergence value of an output variable), and an estimated value of the output variable by an output estimation model, on X-Y plane coordinates. A value of an input variable to a simulation execution model and an output estimation model is indicated on an X-axis. A convergence value of an output variable of the simulation execution model and an estimated value of the output variable by the output estimation model are indicated on a Y-axis.

For example, an error is a difference between a simulation result (convergence value of an output variable) Y_1ₗₐₛₜ_1 and an estimated value Y_1ₑₛₜ_1 which are obtained by inputting a value U_1_1 of an input variable to a simulation execution model and an output estimation model, respectively. In the third example embodiment, generating a model (error estimation model) for estimating the error of an estimated value as described above is described.

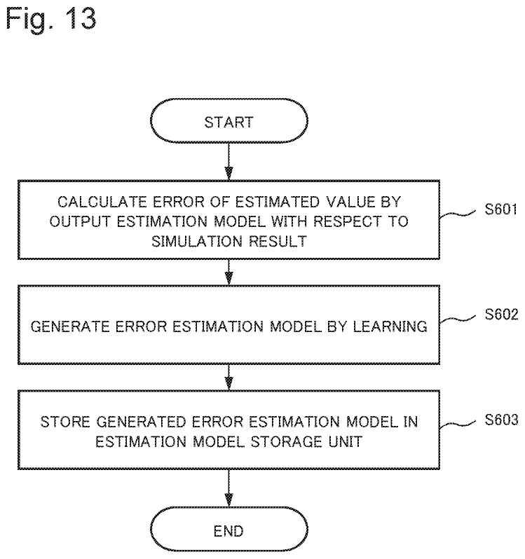

FIG. 13 is a flowchart illustrating processing of generating an error estimation model by the error estimation model generation unit 311. Processing of generating the error estimation model by the error estimation model generation unit 311 is described with reference to FIG. 13.

The error estimation model generation unit 311 generates an error estimation model, based on a convergence value of an output variable being a simulation result, and an estimated value of the output variable by an output estimation model, which is stored in an estimation result storage unit 280. Herein, the estimated value of the output variable by the output estimation model is a value calculated by inputting a value of an input variable and a value of an internal variable of a step used in the output estimation model, to the output estimation model.

First, the error estimation model generation unit 311 calculates an error of an estimated value of an output variable by an output estimation model with respect to a convergence value of the output variable being a simulation result (S601).

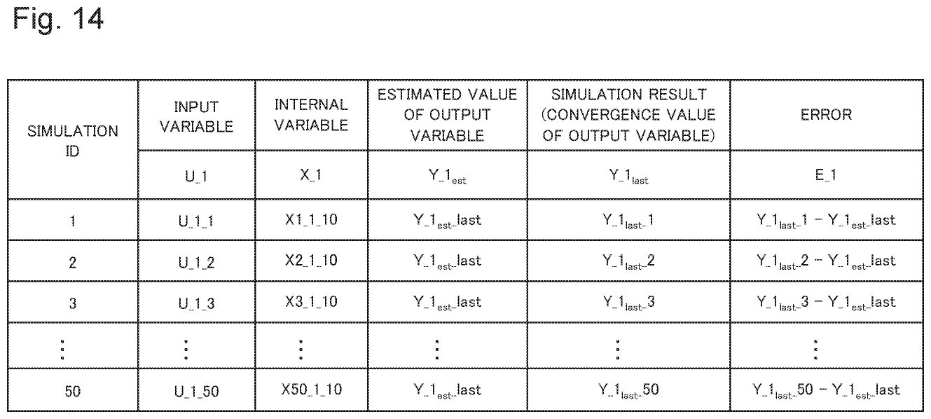

FIG. 14 is a diagram illustrating error data including the above-described error calculated by the error estimation model generation unit 311. FIG. 14 includes an error of an estimated value Y_1ₑₛₜ of an output variable calculated using an output estimation model stored in the estimation model storage unit 250 for the step t=“10” with respect to a convergence value Y_1ₗₐₛₜ of the output variable being a simulation result.

For example, an error E_1 is expressed by the following equation (4).

Error E_1=Y_1ᵢₐₛₜ_1−Y_1ₑₛₜ last Equation (4)

The error estimation model generation unit 311 may store error data including the above-described calculated error in the estimation result storage unit 280.

The error estimation model generation unit 311 learns error data illustrated in FIG. 14 as learning data to generate an error estimation model (S602). Specifically, the error estimation model generation unit 311 learns learning data using explanatory variables indicating a value of an input variable and an updated value of an internal variable, and an objective variable indicating an error to generate the error estimation model.

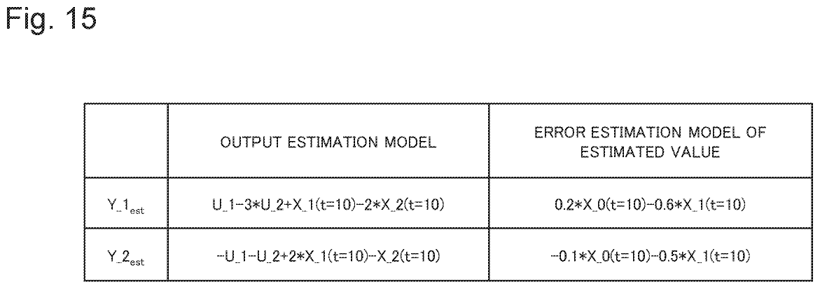

FIG. 15 is a diagram illustrating one example of an output estimation model generated by the output estimation model generation unit 241, and an error estimation model generated by the error estimation model generation unit 311. The output estimation model is similar to the model described in the second example embodiment with reference to FIG. 8. The error estimation model is an output estimation model for the step t=“10” similarly to the output estimation model.

Specifically, the example of FIG. 15 illustrates that equations (5) and (6) are generated as an error estimation model for acquiring an error of estimated values Y_1ₑₛₜ and Y_2ₑₛₜ of output variables.

Error of an estimated value Y_1ₑₛₜ=0.2*X_0(t=10)−0.6*X_1(t=10) Equation (5)

Error of an estimated value Y_2ₑₛₜ=−0.1*X_0(t=10)−0.5*X_1(t=10) Equation (6)

In equation (5), for example, when it is assumed that X_0(t=10)=“9” and X_1(t=10)=“1”, it means that an estimated value Y_1ₑₛₜ of the output variable may include an error of “±0.6”.

The error estimation model generation unit 311 generates the error estimation model according to the above-described procedure, and stores the generated error estimation model in the estimation model storage unit 250 (S603).

Note that it is possible to investigate reliability of an estimated value of an output variable based on an estimated value of an error acquired by the error estimation model generated as described above. Specifically, since there is a possibility that a simulation result is deviated from an estimated value calculated by an output estimation model by an amount corresponding to an error, investigation of an estimated value considering the error is enabled.

For example, when a parameter such that a value of an output variable Y_1 falls below “1” is designed, it is assumed that an estimated value of an output variable using an output estimation model is “0.7”, and an estimated value of an error using an error estimation model is “±0.2” for a certain parameter set

In this case, an estimated value of an output variable Y_1 considering the error becomes “0.5 to 0.9”. Therefore, it is possible to expect that the output variable Y_1 falls below “1”, even when there is an error. In other words, it is clear that designing with the parameter set “P” is allowed.

On the other hand, when an estimated value of an error is “±0.3” for the same estimated value of the output variable, an estimated value of the output variable Y_1 considering the error becomes “0.4 to 1.0”. Therefore, it is predicted that a value of the output variable Y_1 does not fall below “1”, when there is an error. In other words, it is clear that designing with the parameter set “P” is not appropriate.

Note that calculation of an error illustrated in FIG. 14 may be performed concurrently with calculation of an estimated value of an output variable described in the second example embodiment. Specifically, the output estimation model generation unit 241 may calculate an error of an estimated value of the output variable by a generated output estimation model with respect to a simulation result, and generate an output estimation model having a small error.

As described above, according to the third example embodiment, in the information processing device 300, the error estimation model generation unit 311 calculates an error of an estimated value of an output variable by an output estimation model with respect to a simulation result, and generates an error estimation model by learning the error and an updated value of an internal variable.

By employing this configuration, in the third example embodiment, an advantageous effect of enabling parameter designing considering reliability of an estimated value by an output estimation model is acquired.

### Fourth Example Embodiment

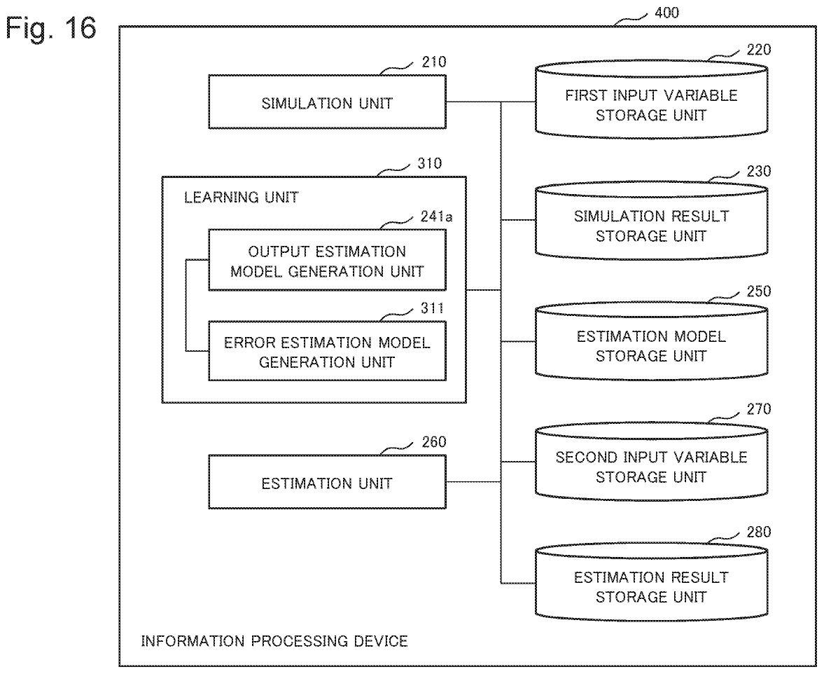

FIG. 16 is a block diagram illustrating a configuration of an information processing device 400 according to a fourth example embodiment of the present invention. As illustrated in FIG. 16, the information processing device 400 according to the fourth example embodiment has a configuration including an output estimation model generation unit 241a, in place of the output estimation model generation unit 241 included in the learning unit 310 of the information processing device 300 described in the third example embodiment. Since other elements are similar to the elements described in the second and third example embodiments, description thereof is omitted.

The output estimation model generation unit 241a has a function of determining precision of an output estimation model, in addition to a function of the output estimation model generation unit 241 described in the second example embodiment. Specifically, the output estimation model generation unit 241a has a function of calculating precision of a generated output estimation model for a certain step, and when the precision does not satisfy a criterion, generating an output estimation model having higher precision.

As described in the third example embodiment, the error estimation model generation unit 311 calculates a difference (error) between an estimated value of an output variable by an output estimation model and a value of a simulation result. The output estimation model generation unit 241a calculates precision of the output estimation model, based on an average value of errors. The output estimation model generation unit 241a may calculate precision of the output estimation model, based on an average value of squares of a difference between the estimated value of the output variable by the output estimation model and the simulation result.

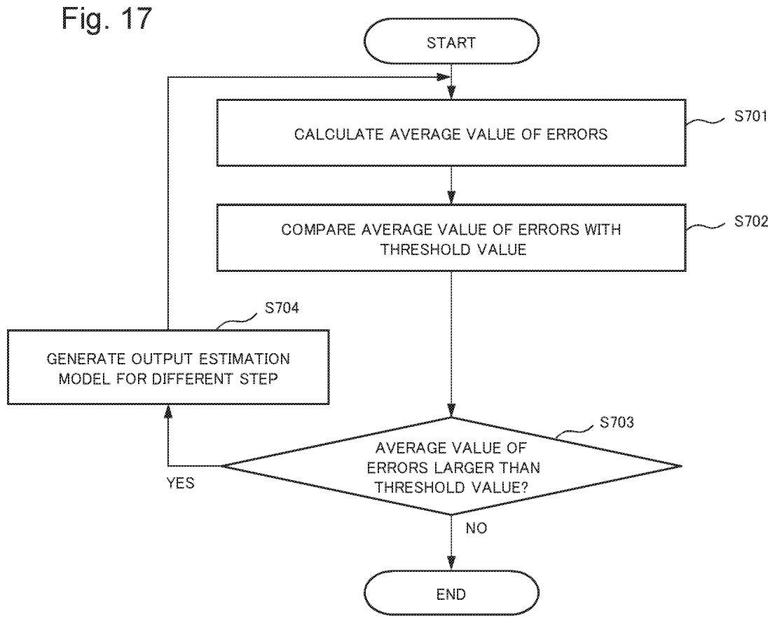

FIG. 17 is a flowchart illustrating processing of the output estimation model generation unit 241a of the information processing device 400 according to the fourth example embodiment. Processing of the output estimation model generation unit 241a is described with reference to FIG. 17.

Herein, it is assumed that a simulation as described in the second example embodiment is executed, and the estimation model storage unit 250 stores an output estimation model for the step t=“10”. Further, as described in the third example embodiment, it is assumed that error data including errors calculated by the error estimation model generation unit 311, as illustrated in FIG. 14, is stored in the estimation result storage unit 280.

The output estimation model generation unit 241a calculates an average value of the errors calculated by the error estimation model generation unit 311 (S701). Specifically, in a case of an example illustrated in FIG. 14, the output estimation model generation unit 241a calculates an average value of errors associated with the simulation IDs=“1” to “50”. The average value indicates precision of the output estimation model for the step t=“10”.

Subsequently, the output estimation model generation unit 241a compares the calculated average value with a threshold value held in advance (S702).

When the average value is larger than the threshold value (Yes in S703), the output estimation model generation unit 241a generates an output estimation model for a different step (S704).

Specifically, the output estimation model generation unit 241a generates an output estimation model for a step t which is larger than a step t for which the output estimation model has been already generated. For example, when an output estimation model for the step t=“10” has been generated, the output estimation model generation unit 241 may generate an output estimation model for the step t=“30”. Note that, the present example embodiment is not limited to generating an output estimation model for a step t larger than a step t for which an output estimation model has been already generated.

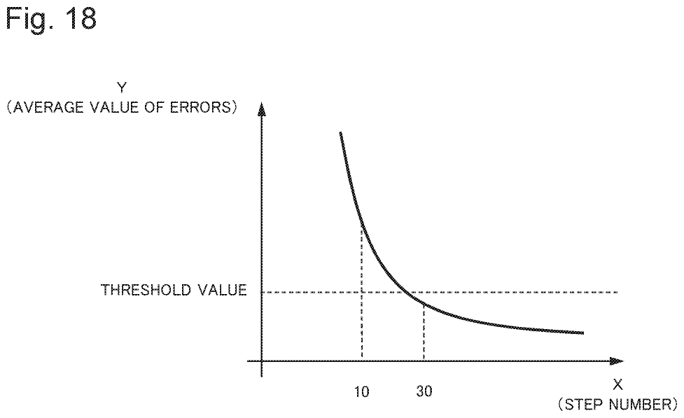

FIG. 18 is a diagram illustrating one example of a relationship between a step number of an output estimation model, and an average value of errors of an estimated value of an output variable by the model, on X-Y plane coordinates. In FIG. 18, the step number of an output estimation model is indicated on an X-axis, and the average value of errors of an estimated value of an output variable by the model is indicated on a Y-axis, respectively.

As illustrated in FIG. 18, an output estimation model for a larger step number has a smaller error, that is, higher precision. This means that an output estimation model generated by learning simulation results with more executed steps has higher precision than an output estimation model generated by learning simulation results with fewer executed steps.

The output estimation model generation unit 241a may generate an output estimation model for the step t=“30”, for example, according to the procedure described with reference to FIG. 7 in the second example embodiment. The output estimation model generation unit 241a calculates an average value of errors of an estimated value, similarly to the above, regarding the generated output estimation model. The output estimation model generation unit 241a generates an output estimation model for a different step until the average value of errors becomes equal to or less than a threshold value.

The output estimation model generation unit 241, when generating an output estimation model whose precision satisfies a criterion, stores the model in the estimation model storage unit 250.

As described above, according to the fourth example embodiment, in the information processing device 400, the output estimation model generation unit 241a calculates precision of an output estimation model, based on an average value of errors between an estimated value of an output variable by the model and a simulation result. When the precision does not satisfy a criterion, the output estimation model generation unit 241a generates a model having higher precision.

By employing the above-described configuration, in the fourth example embodiment, an advantageous effect of enabling acquisition of a simulation output with enhanced precision is acquired, since an estimated value of an output variable is calculated by an output estimation model the precision of which satisfies a criterion.

### Fifth Example Embodiment

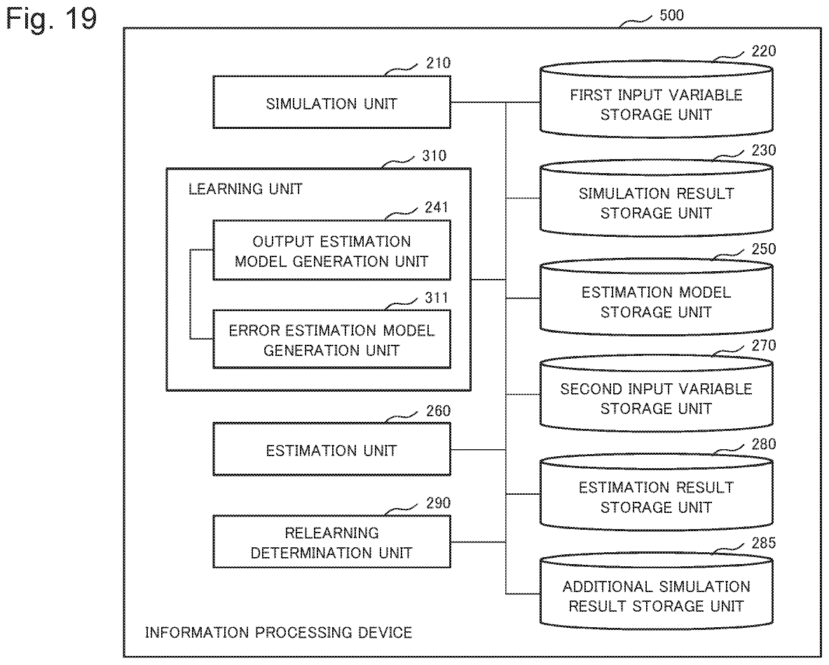

FIG. 19 is a block diagram illustrating a configuration of an information processing device 500 according to a fifth example embodiment of the present invention. As illustrated in FIG. 19, the information processing device 500 according to the fifth example embodiment has a configuration including an additional simulation result storage unit 285 and a relearning determination unit (relearning instruction means) 290, in addition to a configuration of the information processing device 300 described in the third example embodiment. Since other elements are similar to the elements described in the second and third example embodiments, description thereof is omitted.

The additional simulation result storage unit 285 stores an execution result of an additional simulation executed by the simulation unit 210.

The relearning determination unit 290 recalculates precision of an estimated value by an output estimation model, the precision of which is determined to satisfy a criterion by the output estimation model generation unit 241, as described in the fourth example embodiment, and instructs to relearn as necessary.

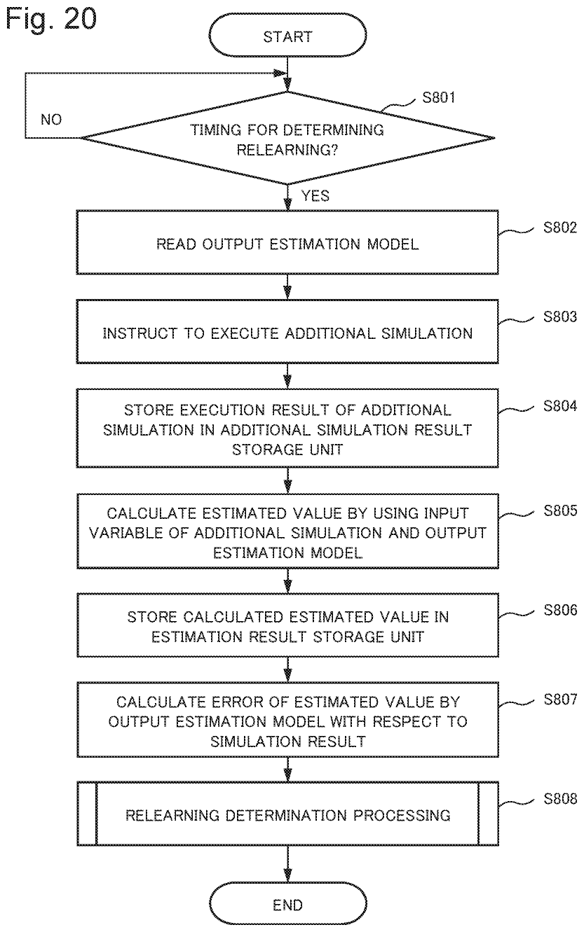

FIG. 20 is a flowchart illustrating processing of the relearning determination unit 290. Processing of the relearning determination unit 290 is described with reference to FIG. 20. Herein, it is assumed that the output estimation model generation unit 241 stores an output estimation model for the step t=“30” in the estimation model storage unit 250, as an output estimation model whose precision satisfies a criterion, as described in the fourth example embodiment.

At a timing for determining relearning (Yes in S801), the relearning determination unit 290 reads an output estimation model from the estimation model storage unit 250 (S802). The relearning determination unit 290 may perform determination of relearning at a predetermined timing (e.g., a timing when a predetermined amount of estimated values by the output estimation model are accumulated), or at any timing.

Subsequently, the relearning determination unit 290 instructs the simulation unit 210 to execute an additional simulation (S803). The relearning determination unit 290 may provide the simulation unit 210 with a value of an input variable different from a first input variable stored in a first input variable storage unit 220, as an input variable. Further, a value of the input variable may be given from the outside.

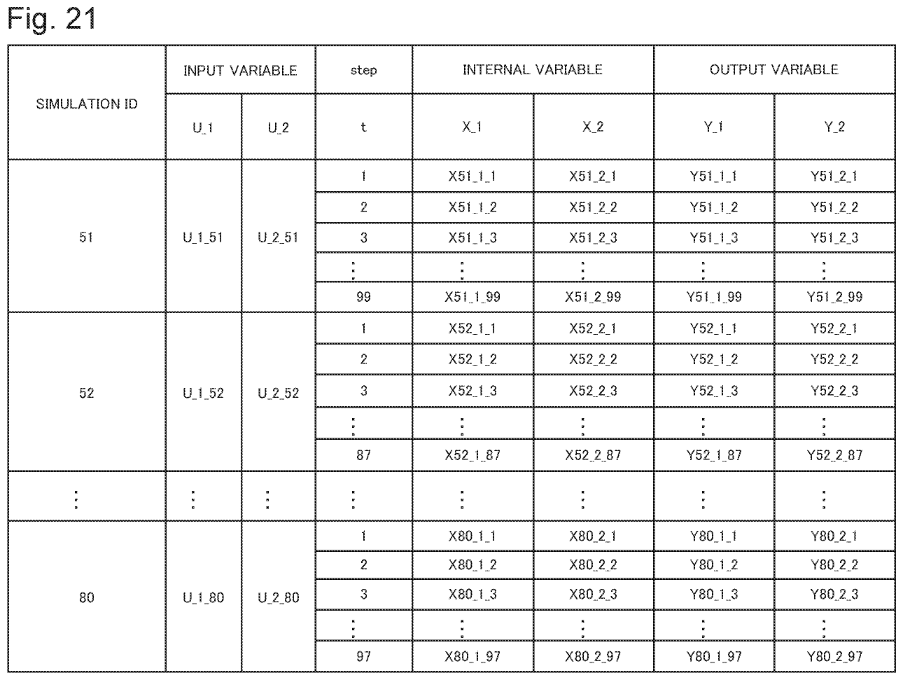

The simulation unit 210 executes an additional simulation in response to the instruction, and stores an execution result of the simulation in the additional simulation result storage unit 285 (S804). FIG. 21 is a diagram illustrating one example of values of input variables, updated values of internal variables, and values of output variables written in the additional simulation result storage unit 285, as a result of executing the additional simulation. FIG. 21 illustrates values of input variables, updated values of internal variables of each step, and values of output variables, which are associated with the simulation IDs=51 to 80. Data stored in the additional simulation result storage unit 285 used as data for additional learning.

Subsequently, the relearning determination unit 290 calculates an estimated value by inputting, to the output estimation model read in the processing S802, the value of the input variable used for executing the additional simulation (S805).

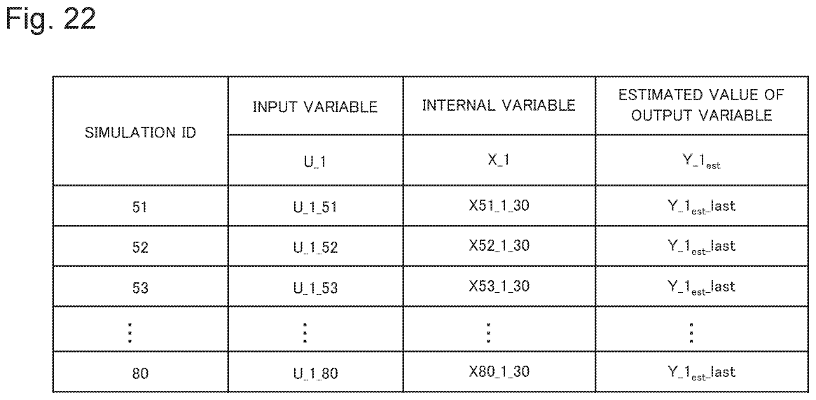

The relearning determination unit 290 stores, in the estimation result storage unit 280, the estimation result including the calculated estimated value (S806). FIG. 22 is a diagram illustrating one example of estimation results calculated by the relearning determination unit 290. Herein, FIG. 22 illustrates estimated values by the output estimation model for the step t=“30”.

Subsequently, the relearning determination unit 290 calculates an error of the estimated value by the output estimation model with respect to the simulation result (convergence value of the output variable), similarly to the error estimation model generation unit 311 in the second example embodiment (S807). Further, the relearning determination unit 290 executes relearning determination processing, based on the error (S808).

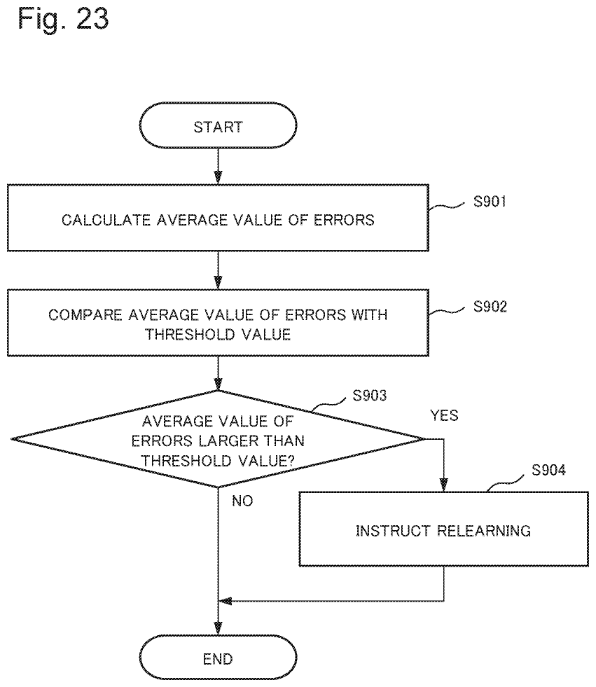

FIG. 23 is a flowchart describing the relearning determination processing by the relearning determination unit 290. Processing of the relearning determination by the relearning determination unit 290 is described with reference to FIG. 23.

The relearning determination unit 290 calculates an average value of errors calculated in the processing S807, similarly to the operation described in the fourth example embodiment with reference to FIG. 17 (S901).

Subsequently, the relearning determination unit 290 compares the calculated average value of errors with a threshold value held in advance (S902).

When the average value of errors is larger than the threshold value (Yes in S903), the relearning determination unit 290 instructs the output estimation model generation unit 241 to relearn (S904).

In response to a relearning instruction, the output estimation model generation unit 241 adds the additional simulation results stored in the additional simulation result storage unit 285 to learning data, and performs relearning. Specifically, the output estimation model generation unit 241 learns learning data stored in the simulation result storage unit 230 and the additional learning data stored in the additional simulation result storage unit 285 to generate an output estimation model.

Note that the present example embodiment is not limited to a configuration in which the output estimation model generation unit 241 learns all pieces of learning data and all pieces of additional learning data in relearning. The output estimation model generation unit 241 may learn all pieces of learning data and a part of additional learning data, or a part of learning data and all pieces of additional learning data. For example, the output estimation model generation unit 241 is able to increase precision of the generated estimation model by gathering and learning only results under the same simulation condition.

Alternatively, the output estimation model generation unit 241 may learn only additional learning data. For example, in a case that an estimation model is learned in a temperate climate condition, but a different estimation model has higher precision in a cold climate condition, the output estimation model generation unit 241 may re-generate an estimation model by learning only additional learning data.

At this occasion, the output estimation model generation unit 241 may generate an output estimation model for the step t=“30”. Alternatively, the output estimation model generation unit 241 may select an internal variable to be used as an explanatory variable of the output estimation model as described in the second example embodiment.

As described above, in the fifth example embodiment, in the information processing device 500, the simulation unit 210 executes an additional simulation, and the relearning determination unit 290 calculates precision of an output estimation model, based on an average value of errors between an execution result of the additional simulation and an estimated value of an output variable by the output estimation model. When the precision does not satisfy a criterion, the relearning determination unit 290 relearns learning data including the execution result of the additional simulation as additional learning data to generate an output estimation model.

By employing the above-described configuration, in the fifth example embodiment, an advantageous effect of enabling acquisition of a simulation output with higher precision is acquired, since precision is calculated for a generated output estimation model, and when the precision does not satisfy a criterion, a model is re-generated by relearning using an execution result of an additional simulation.

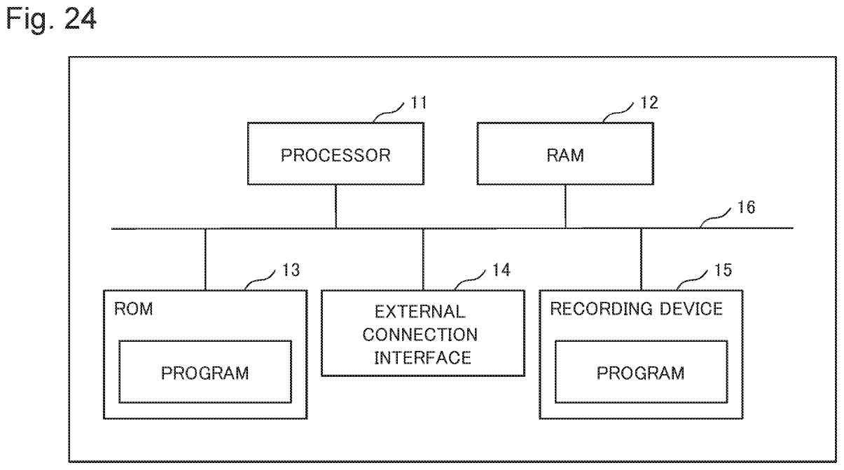

Note that each unit of the information processing device illustrated in FIG. 1 and the like is implemented by a hardware resource exemplified in FIG. 24. Specifically, a configuration illustrated in FIG. 24 includes a processor 11, a random access memory (RAM) 12, a read only memory (ROM) 13, an external connection interface 14, a recording device 15, and a bus 16 for connecting the constituent elements.

In the above-described example embodiments, as one example to be executed by the processor 11 illustrated in FIG. 24, a case is described in which, after a computer program capable of implementing the above-described function is supplied to an information processing device, the function is implemented by causing the processor 11 to read the computer program on the RAM 12 and execute the computer program. However, a part or the entirety of a function indicated by each block of the information processing device illustrated in FIG. 1 and the like may be implemented as a hardware. Specifically, a part or the entirety of each constituent element of each device is implemented by a general-purpose or dedicated circuitry, a processor, or the like, or combination of these elements. These elements may be configured by a single chip, or may be configured by a plurality of chips to be connected via a bus. A part or the entirety of each constituent element of each device may be implemented by combination of the above-described circuitry or the like, and the program.

When a part or the entirety of each constituent element of each device is implemented by a plurality of information processing devices, a circuitry, or the like, the plurality of information processing devices, the circuitry, or the like may be concentratedly disposed or distributively disposed. For example, an information processing device, a circuitry, or the like may be implemented as a configuration in which a client-and-server system, a cloud computing system, and the like are connected to each other via a communication network.

A computer program supplied to an information processing device as described above may be stored in a computer readable storage device such as a readable and writable memory (temporary storage medium), a hard disk device, or the like. Further, in such a case, it can be regarded that the present invention is configured by codes representing the computer program, or a storage medium storing the computer program.

While the invention has been particularly shown and described with reference to exemplary embodiments thereof, the present invention is not limited to these embodiments. It will be understood by those of ordinary skill in the art that various changes in form and details may be made therein without departing from the spirit and scope of the present invention as defined by the claims.

This application is based upon and claims the benefit of priority based on Japanese Patent Application No. 2017-015776 filed on Jan. 31, 2017, the disclosure of which is incorporated herein in its entirety by reference.

### REFERENCE SIGNS LIST

11 Processor
12 RAM
13 ROM
14 External connection interface
15 Recording device
16 Bus
100 to 500 Information processing device
110 Simulation unit
120 Learning unit
210 Simulation unit
220 First input variable storage unit
230 Simulation result storage unit
240 Learning unit
241 Output estimation model generation unit
250 Estimation model storage unit
260 Estimation unit
270 Second input variable storage unit
280 Estimation result storage unit
285 Additional simulation result storage unit
290 Relearning determination unit
310 Learning unit
311 Error estimation model generation unit

What is claimed is:

1. An information processing device comprising:
a memory storing instructions; and
one or more processors configured to execute the instructions to:
acquire a value of an input variable used for executing a simulation, an updated value of an internal variable updated during execution of the simulation, and a value of an output variable indicating a result of the simulation; and
learn an estimation model for estimating a simulation result by using the input variable and the updated internal variable acquired as explanatory variables and the output variable acquired as an objective variable.

2. The information processing device according to claim 1, wherein
a value of the output variable after the simulation result converges is acquired.

3. The information processing device according to claim 2, wherein
the one or more processors are further configured to execute the instructions to:
input, to the learned estimation model, a new value of the input variable used for a simulation in which a convergence result is not acquired and an updated value of the internal variable updated during execution of the simulation using the new value, and estimate a convergence result of the simulation using the new value.

4. The information processing device according to claim 2, wherein
the simulation is processing of repeating a step including updating a value of the internal variable based on a value of the input variable and generating a value of the output variable, until the value of the output variable converges,
the value of the internal variable is acquired for each step, and
the estimation model is learned by using the internal variable updated in a step and the internal variable updated in another step, respectively, as explanatory variables.

5. The information processing device according to claim 4, wherein
the one or more processors are further configured to execute the instructions to:
select as an explanatory variable, the internal variable updated in a small step number prior to the internal variable updated in a large step number to learn the estimation model.

6. The information processing device according to claim 2, wherein
the one or more processors are further configured to execute the instructions to:
learn based on a value of the input variable, an updated value of the internal variable, and an error between the estimated value estimated by using the estimation model and a value of the output variable after the simulation result converges, an error estimation model for estimating an error of the estimated value.

7. The information processing device according to claim 4, wherein
the one or more processors are further configured to execute the instructions to:
calculate precision of the estimation model, based on an error between an estimated value estimated by using the estimation model and a value of the output variable after the simulation result converges, and,
when the precision does not satisfy a criterion, learn the estimation model by using, as the explanatory variables, a value of the input variable and an internal variable updated in a step number larger than a step number used as the explanatory variable.

8. The information processing device according to claim 4, wherein
the one or more processors are further configured to execute the instructions to:
calculate precision of the estimation model, based on an error between an estimated value estimated by using a new value of the input variable used for executing the simulation, an updated value of the internal variable updated during execution of the simulation using the new value, and the estimation model and a value of the output variable after a simulation result using the new value converges, and,
when the precision does not satisfy a criterion, instruct to learn the estimation model, based on the new value, the updated value of the internal variable updated during the simulation using the new value, and the value of the output variable after the simulation result using the new value converges.

9. An information processing method comprising:
acquiring a value of an input variable used for executing a simulation, an updated value of an internal variable updated during execution of the simulation, and a value of an output variable indicating a result of the simulation; and
learning an estimation model for estimating a simulation result by using the input variable and the updated internal variable acquired by the acquisition means as explanatory variables and the output variable acquired by the acquisition means as an objective variable.

10. A non-transitory computer readable storage medium recording thereon a program, causing a computer to execute processes comprising:
acquiring a value of an input variable used for executing a simulation, an updated value of an internal variable updated during execution of the simulation, and a value of an output variable indicating a result of the simulation; and
learning an estimation model for estimating a simulation result by using the input variable and the updated internal variable acquired by the acquisition means as explanatory variables and the output variable acquired by the acquisition means as an objective variable.
